(19) United States
(12) Patent Application Publication
(10) Pub. No.: US 2007/0159953 A1
(43) Pub. Date: Jul. 12, 2007

(54) Optical disc apparatus

(75) Inventor: Yuichi Kamioka, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/651,568

(22) Filed: Jan. 10, 2007

(30) Foreign Application Priority Data
Jan. 11, 2006 (JP) 2006-004054

(51) Int. Cl. G11B 7/00

(52) U.S. Cl. 369/116; 369/112.02; 369/44.23

(57) ABSTRACT

An optical disc apparatus includes a liquid crystal driver, a laser driver, a storage portion, and a control portion for controlling them, the storage portion stores a correction table of current to be supplied to a laser beam source with a parameter of a voltage to be applied to a liquid crystal element, and the control portion looks up the correction table and determines a correction value of the current for driving the laser beam source in accordance with the voltage to be applied to the liquid crystal element.

This application is based on Japanese Patent Application No. 2006-004054 filed on Jan. 11, 2006, the contents of which are hereby incorporated by reference.

### BACKGROUND OF THE INVENTION

1. Field of the Invention

The present invention relates to an optical disc apparatus for reproducing information from an optical disc or recording information on an optical disc, which can maintain quantity of effective light of a laser beam that is projected to the optical disc.

2. Description of Related Art

An optical disc that can reproduce information by projection of a laser beam is used as a recording medium for information such as images and sounds. The optical disc includes a CD (Compact Disc) and a DVD (Digital Versatile Disc) having higher density (more recording capacity) that are available. Recently, a BD (Blu-ray Disc) having higher density (more recording capacity) than the DVD has become available in the market. The optical disc apparatus, which uses the above mentioned optical discs as a recording medium, rotates the optical disc and projects a laser beam to a recording surface of the optical disc so as to reproduce information recorded on the optical disc.

Usually, an optical disc apparatus has a single optical head that supports reading and writing a CD, a DVD and a BD for saving space and cost of the optical disc apparatus. In addition, since the laser beams have different wavelengths for a DVD and a BD, the optical head has laser beam sources that can emit laser beams having corresponding wavelengths. The optical head is provided with an objective lens facing the optical disc, and the laser beam that is emitted from the laser beam source and passed through an optical system of the optical head is condensed on a recording layer of the optical disc after passing through the objective lens.

When the laser beam passes through the objective lens, aberration is generated in the laser beam. In addition, the optical disc has a structure including a cover glass layer that is a protection layer disposed on the recording layer, so aberration is generated when the laser beam passes through the cover glass layer. Usually, the objective lens is designed to support one type of optical disc (a BD in many cases), and the aberration generated in the laser beam after passing through the objective lens is canceled with aberration generated by the cover glass layer of the BD. Thus, the laser beam is condensed on the recording layer as the laser beam with little wave aberration.

However, each of a CD and a DVD has a thickness of the cover glass layer, a wavelength of the corresponding laser beam, and a numerical aperture NA of the objective lens that are different from those for a BD. Therefore, if an objective lens for a BD is used for condensing the laser beam on the recording layer of a CD or a DVD, wave aberration having a large aberration component will be generated in the laser beam that is projected to the recording layer of the optical disc such as a CD or a DVD. In addition, there is a type of a BD that has a two-layer structure in which two recording layers are provided to the upper and the lower sides. In this case, if the laser beam is projected by using the objective lens that supports one of the two recording layers, a laser beam that is condensed on the other recording layer will include wave aberration having a large aberration component.

If the wave aberration having a large aberration component is generated, a condensing point of the laser beam that is condensed on the recording surface of the optical disc (hereinafter referred to as a laser spot) may have a large spot diameter, or a dim circular light (a halo) may be formed around the laser spot. As a result, cross talk or jitter may be increased, and accuracy in reproducing information from the optical disc or recording information on the optical disc may be lowered.

Therefore, as disclosed in JP-A-2001-222838, there is a technique in which aberration of a laser beam projected to each optical disc is corrected by using a liquid crystal element.

In addition, in order that the laser beam forms a laser spot on the recording surface of each optical disc accurately, a technique disclosed in JP-A-2002-288832 for example, disposes a liquid crystal element between the laser beam source and the objective lens. Voltages that are applied to the liquid crystal element are controlled so that a laser beam is projected on the recording surface of the optical disc with a small spot diameter.

However, when the liquid crystal element is used for correcting the aberration (spherical aberration) of the laser beam as described in JP-A-2001-222838, all the aberration components that cannot be corrected become unavailable light as high order aberration. Therefore, intensity of effective light that contributes to recording and reproducing inherently will be lowered. If the intensity of the effective light is lowered, intensity of the laser spot formed on the recording layer is decreased, so that accuracy in reproducing or recording information may be deteriorated.

In addition, the technique disclosed in JP-A-2002-288832 utilizes a tilt correction in which a liquid crystal element is used for correcting an angle of the laser beam with respect to the optical disc, so that a decrease of power of the laser beam due to the tilt correction is compensated by correcting an output power of the laser beam source. The optical disc apparatus in this conventional structure cannot correct spherical aberration that is generated when a type of the optical disc is changed among a CD, a DVD, a BD and the like. In other words, it cannot correct the spherical aberration that is generated due to a difference of thickness from the surface of the cover glass layer to the recording surface, so there may be the case where information cannot be reproduced or recorded accurately.

### SUMMARY OF THE INVENTION

In view of the above described problems, it is an object of the present invention to provide an optical disc apparatus that can use a plurality of types of optical discs as a recording medium and can increase quality in reproducing information recorded on the optical disc and/or recording information on an optical disc regardless of a type of the inserted optical disc by maintaining intensity of a laser beam condensed on a recording surface of the optical disc.

It is another object of the present invention to provide an optical disc apparatus that can use a plurality of types of optical discs as a recording medium and can increase quality in reproducing information recorded on the optical disc and/or recording information on an optical disc regardless of a type of the inserted optical disc and temperature of a liquid crystal element for correcting aberration, by maintaining intensity of a laser beam condensed on a recording surface of the optical disc.

In order to attain the above described object, an optical disc apparatus according to one aspect of the present invention includes a plurality of laser beam source for emitting laser beams having different wavelengths, an objective lens for condensing a laser beam emitted from one of the plurality of laser beam source on a recording surface of one of optical discs including a CD, a DVD and a BD, a liquid crystal element for permitting the laser beam to pass through so that aberration of the laser beam is corrected, a liquid crystal driver for applying a drive voltage to the liquid crystal element, a laser driver for supplying current for driving the laser beam source to the same, a storage portion for storing various types of information, and a control portion for controlling the liquid crystal driver, the laser driver and the storage portion. The storage portion stores a correction table of the current to be supplied to the laser beam source with a parameter of the voltage to be applied to the liquid crystal element. The control portion looks up the correction table when the laser beam is projected to the optical disc, and the control portion determines a correction value of the current for driving the laser beam source in accordance with the voltage to be applied to the liquid crystal element.

According to this structure, aberration of the laser beam that is projected to the recording layer of the optical disc can be corrected, and a precise laser spot can be formed on the track of the recording layer. In addition, when the aberration is corrected by the liquid crystal element, it is possible to avoid a decrease of intensity of the laser beam due to aberration components that cannot be corrected. As a result, intensity of reflection light reflected by the recording layer of the optical disc can be increased. Thus, information recorded on the optical disc can be reproduced accurately.

In addition, since intensity of the laser beam projected to the recording layer of the optical disc can be maintained at constant value or a substantially constant value, it is possible to avoid projecting a laser beam having excessive intensity that exceeds an allowable value for the recording layer.

Thus, it is possible to prevent a generation of malfunction such as destruction or deletion of information on the optical disc due to damage to the recording layer caused when a laser beam having excessive intensity is projected to the recording layer of the optical disc.

Preferably in the structure described above, the optical disc apparatus includes a liquid crystal temperature sensing portion for sensing temperature of the liquid crystal element, the correction table includes temperature of the liquid crystal element as the parameter, and the control portion determines the correction value of the current for driving the laser beam source in accordance with the voltage to be applied to the liquid crystal element and the temperature of the liquid crystal element sensed by the liquid crystal temperature sensing portion.

More preferably in the structure described above, the liquid crystal element is provided with a disk like transparent electrode disposed on a liquid crystal layer and a plurality of circular transparent electrodes arranged in a concentric manner around the disk like transparent electrode with being insulated from each other, and the liquid crystal driver applies the voltage to each of the plurality of transparent electrodes independently.

The optical disc apparatus described above can be a read only device. In addition, it can be a reading and writing device that can record information on the recording layer by projecting a laser beam to the optical disc and can also reproduce information by detecting reflection light.

In order to attain the above described object, an optical disc apparatus according to another aspect of the present invention is a device for reproducing information by projecting a laser beam on a recording surface of an optical disc and detecting a reflection light of the laser beam, and it includes a blue color laser beam source for emitting a first laser beam of a blue color, a red color laser beam source for emitting a second laser beam of a red color or infrared, an objective lens for condensing the first or the second laser beam on a recording surface of one of optical discs including a CD, a DVD and a BD, a liquid crystal element having a liquid crystal layer, a disk like transparent electrode disposed on the liquid crystal layer and a plurality of circular transparent electrodes surrounding the disk like transparent electrode in a concentric manner with being separated from each other for changing refractive index of the liquid crystal layer by applying voltages to the plurality of transparent electrodes so that aberration of the laser beam passing through the liquid crystal layer is corrected, a liquid crystal temperature sensing portion for sensing temperature of the liquid crystal element, a liquid crystal driver for applying voltages to the plurality of transparent electrodes independently, a laser driver for supplying current for driving one of the blue color laser beam source and the red color laser beam source in accordance with a type of the optical disc to which the laser beam is projected, a memory for storing various types of information, and a control portion for controlling the liquid crystal temperature sensing portion, the liquid crystal driver, the laser driver and the memory. The memory stores a correction table of the current for driving to be supplied to the blue color laser beam source or the red color laser beam source with parameters that are the temperature of the liquid crystal element and the voltages to be applied to the plurality of transparent electrodes. The control portion looks up the correction table when the laser beam is projected to the optical disc, and the control portion determines a correction value of the current for driving the blue color laser beam source or the red color laser beam source in accordance with the voltages to be applied to the plurality of transparent electrodes and the temperature of the liquid crystal element sensed by the liquid crystal temperature sensing portion.

According to this structure, aberration of the laser beam that is projected to the recording layer of the optical disc can be corrected, and a precise laser spot can be formed on the track of the recording layer. In addition, when the aberration is corrected by the liquid crystal element, it is possible to avoid a decrease of intensity of the laser beam due to aberration components that cannot be corrected. As a result, intensity of reflection light reflected by the recording layer of the optical disc can be increased. Thus, information recorded on the optical disc can be reproduced accurately.

In addition, since intensity of the laser beam projected to the recording layer of the optical disc can be maintained at constant value or a substantially constant value, it is possible to avoid projecting a laser beam having excessive intensity that exceeds an allowable value for the recording layer.

Thus, it is possible to prevent a generation of malfunction such as destruction or deletion of information on the optical disc due to damage to the recording layer caused when a laser beam having excessive intensity is projected to the recording layer of the optical disc.

According to the present invention, it is possible to provide an optical disc apparatus that can use a plurality of types of optical discs as a recording medium and can increase quality in reproducing information recorded on the optical disc and/or recording information on an optical disc regardless of a type of the inserted optical disc by maintaining intensity of a laser beam condensed on a recording surface of the optical disc.

According to the present invention, it is possible to provide an optical disc apparatus that can use a plurality of types of optical discs as a recording medium and can increase quality in reproducing information recorded on the optical disc and/or recording information on an optical disc regardless of a type of the inserted optical disc and temperature of a liquid crystal element for correcting aberration, by maintaining intensity of a laser beam condensed on a recording surface of the optical disc.

### BRIEF DESCRIPTION OF THE DRAWINGS

FIG. 1 is a diagram to show a structure of an optical disc apparatus according to one embodiment of the present invention.

FIG. 2 shows a table of main numeric data of a BD, a DVD and a CD.

FIGS. 3A and 3B show a liquid crystal element that is used for the optical disc apparatus according to the present invention, FIG. 3A is a plan view, and FIG. 3B is a cross sectional view.

FIGS. 4A-4C show a relationship between the liquid crystal element and a phase, FIG. 4A is a cross sectional view of the liquid crystal element, FIG. 4B is a schematic diagram to show a correction pattern of a phase when voltages are applied to transparent electrodes of the liquid crystal element, and FIG. 4C is a schematic diagram of wave aberration before correction generated on a recording layer of a DVD medium when the DVD medium is read, and FIG. 4D is a schematic diagram of wave aberration when a laser beam is condensed on the recording layer of the DVD medium after being corrected by the liquid crystal element.

FIG. 5 is a schematic diagram to show an intensity distribution of the laser beam.

FIG. 6 shows one embodiment of a correction table that is used by the optical disc apparatus according to the present invention.

FIG. 7 is a diagram to show a schematic arrangement of the optical disc apparatus according to another embodiment of the present invention.

### DESCRIPTION OF THE PREFERRED EMBODIMENTS

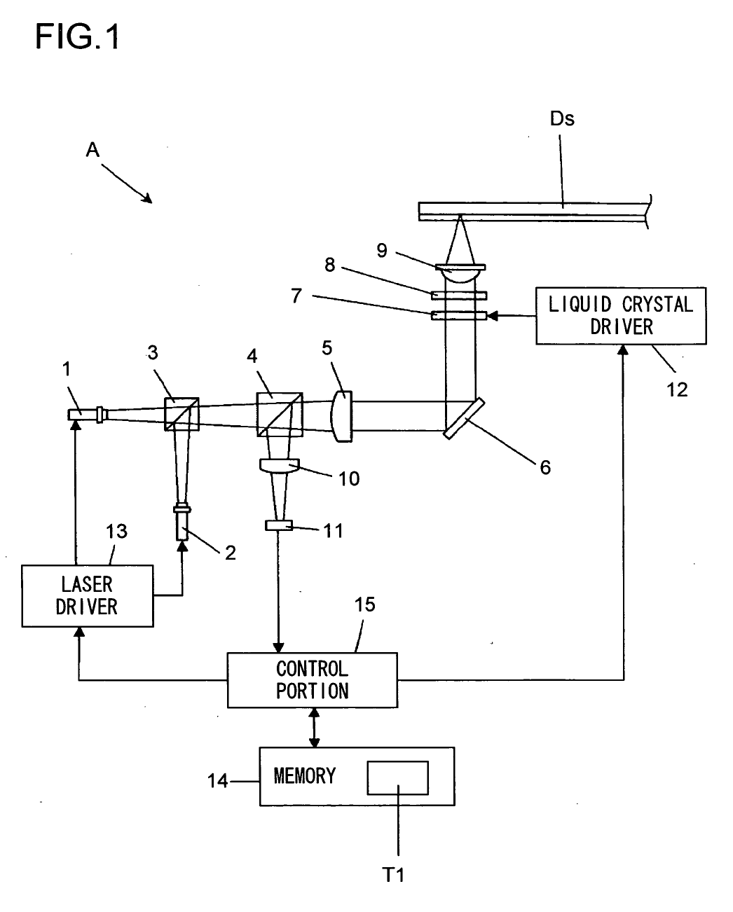

Now an embodiment of the present invention will be described with reference to the attached drawings. FIG. 1 is a diagram to show a structure of an optical disc apparatus according to one embodiment of the present invention. An optical disc apparatus A shown in FIG. 1 can read three types of optical discs including a CD (Compact Disc) medium, a DVD (Digital Versatile Disc) medium and a BD (Blu-ray Disc) medium.

The optical disc apparatus A is equipped with a blue color laser beam source 1, a red color laser beam source 2, a dichroic prism 3, a polarizing beam splitter 4, a collimator lens 5, a mirror 6, a liquid crystal element 7, a quarter wavelength plate 8, an objective lens 9, a cylindrical lens 10, a light receiving portion 11, a liquid crystal driver 12, a laser driver 13, a memory 14, and a control portion 15.

The blue color laser beam source 1 emits a blue color laser beam (having a wavelength of 405 nm) and is used for reading a BD medium. In addition, the red color laser beam source 2 emits a red color laser beam for reading a DVD medium (having a wavelength of 650 nm) and an infrared laser beam for reading a CD medium (having a wavelength of 780 nm). The laser beam emitted from the blue color laser beam source 1 or the red color laser beam source 2 is a laser beam of linear polarization.

The dichroic prism 3 reflects a laser beam of a specific wavelength and permits laser beams having other wavelengths to pass through. The dichroic prism 3 that is used in the optical disc apparatus A permits the laser beam emitted from the blue color laser beam source 1 to pass through and reflects the red color laser beam or the infrared laser beam emitted from the red color laser beam source 2. The laser beam having each wavelength enters the polarizing beam splitter 4 that is disposed after the dichroic prism 3.

The polarizing beam splitter 4 is a prism that permits the laser beam of linear polarization to pass through or reflects the same in accordance with its direction of polarization. The laser beams emitted from the blue color laser beam source 1 and the red color laser beam source 2 are laser beams of linear polarization that can pass through the polarizing beam splitter 4. In addition, the laser beam that passed through the polarizing beam splitter 4 enters the collimator lens 5. The collimator lens 5 converts the passing laser beam of divergent rays into parallel rays.

The quarter wavelength plate 8 converts polarization of the passing laser beam from linear polarization into circular polarization or from circular polarization into linear polarization. The laser beam that passed through the quarter wavelength plate 8 is converted into light having circular polarization, which is reflected by the optical disc Ds. When it passes through the quarter wavelength plate 8 again, it is converted into light of linear polarization. The laser beam passes through the quarter wavelength plate 8, is reflected by the optical disc, and passes through the quarter wavelength plate 8 again, so a direction of linear polarization of the laser beam is rotated by 90 degrees. In other words, the laser beam that enters the quarter wavelength plate 8 before being reflected by the optical disc Ds has linear polarization in the direction of passing through the polarizing beam splitter 4, while the laser beam that is reflected by the optical disc and passed through the quarter wavelength plate 8 has linear polarization in the direction of being reflected by the polarizing beam splitter 4.

The objective lens 9 condenses the laser beam that passed through the quarter wavelength plate 8 on the recording layer of the optical disc Ds. In this embodiment the objective lens 9 is an objective lens supporting a BD medium though it is not a limitation. The objective lens 9 supporting a BD is formed to have a shape for suppressing generation of aberration when the laser beam is condensed on the recording layer of the BD medium.

The light receiving portion 11 receives the laser beam that is reflected by polarizing beam splitter 4 and passes through the cylindrical lens 10. The light receiving portion 11 converts the received laser beam into an electric signal, which is sent to the control portion 15. The light receiving portion 11 in this embodiment utilizes a photoelectric element though it is not a limitation. The cylindrical lens 10 is a lens that can condense light only in one direction, which is used for sensing.

The laser driver 13 supplies current to the blue color laser beam source 1 or the red color laser beam source 2 for driving the same. The laser driver 13 can be an electric circuit for supplying current, for example. The memory 14 stores various types of information of the optical disc apparatus A. The memory 14 stores a correction table that will be described later. The control portion 15 is connected to the light receiving portion 11, the liquid crystal driver 12, the laser driver 13, and the memory 14 for controlling them. In this embodiment the memory 14 can be a combination of a writable RAM (Random Access Memory), a read only ROM (Read Only Memory), and the like, although it is not a limitation. In addition, the control portion 15 can include a processing unit such as a CPU or a microprocessor.

A procedure for reading information recorded on the optical disc Ds by using the optical disc apparatus A is as follows. First, the laser beam that is emitted from the blue color laser beam source 1 and passed through the dichroic prism 3 or the laser beam that is emitted from the red color laser beam source 2 and is reflected by the dichroic prism 3 enters the polarizing beam splitter 4. The polarizing beam splitter 4 is a prism that permits light to pass through or refracts light in accordance with its direction of polarization. The laser beam is emitted from the blue color laser beam source 1 or the red color laser beam source 2 so that the light from the dichroic prism 3 passes through the polarizing beam splitter 4. The laser beam that passed through the polarizing beam splitter 4 is converted into parallel rays by the collimator lens 5, is reflected by the mirror 6, and enters the liquid crystal element 7. The liquid crystal element 7 corrects aberration as described later. If correction of aberration is necessary (in the case where a DVD medium or a CD medium is read, for example), aberration is corrected before the laser beam enters the quarter wavelength plate 8. The laser beam that passed through the quarter wavelength plate 8 is converted into light of circular polarization from light of linear polarization, and the converted light enters the objective lens 9.

The laser beam that entered the objective lens 9 is condensed on the recording layer of the optical disc Ds and is projected to make a laser spot. The laser beam is condensed to be a laser spot on a track that is formed on the recording layer and is reflected by the recording layer. Then, the laser beam becomes to have circular polarization rotating in the direction opposite to the direction of polarization of the laser beam before the reflection. When this light having circular polarization of the opposite direction passes through the objective lens 9 and the quarter wavelength plate 8, it is converted into light of the linear polarization. In this case, the direction of polarization of the converted laser beam is a direction that is perpendicular to the direction of polarization of the laser beam that passed through the polarizing beam splitter 4.

The laser beam that passed through the quarter wavelength plate 8 is reflected by the mirror 6 after passing through the liquid crystal element 7, and it is converted into converging rays from the parallel rays when it passes through the collimator lens 5. The laser beam that passed through the collimator lens 5 is reflected by the polarizing beam splitter 4, passes through the cylindrical lens 10, and enters the light receiving portion 11. The light receiving portion 11 converts the laser beam into an electric signal, which is sent to the control portion 15. The control portion 15 transmits the received electric signal to a signal processing portion (not shown) and sends instructions to the laser driver 13 and the liquid crystal driver 14 based on a control signal included in the electric signal, if necessary.

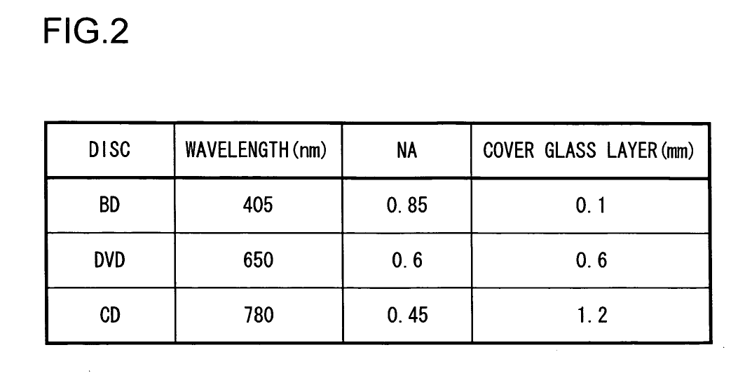

Next, optical discs that can be read by the optical disc apparatus according to the present invention will be described. FIG. 2 shows a table of main numeric data of a BD, a DVD and a CD. Each of a BD medium, a DVD medium, and a CD medium have a cover glass layer that is a protection layer on the recording layer. This cover glass layer has thickness of 0.1 mm in a BD medium, 0.6 mm in a DVD medium and 1.2 mm in a CD medium as shown in the table of FIG. 2. In addition, wavelengths of corresponding lasers and numerical apertures (NA) of the objective lenses are 405 nm (wavelength) and 0.85 (NA) for a BD medium, 650 nm (wavelength) and 0.6 (NA) for a DVD medium, and 780 nm (wavelength) and 0.45 (NA) for a CD medium, respectively.

As described above, the optical disc apparatus A uses the objective lens 9 that supports a BD medium. When this objective lens 9 that supports a BD medium is used for reading a DVD medium or a CD medium, wave aberration may be generated in the laser beam that is condensed on the recording layer of the DVD medium or the CD medium because the DVD medium and the CD medium have the thickness of the cover glass layers and wavelengths and NAs of the laser beams different from those of the BD medium as described above.

If the wave aberration is generated, a focused point of the laser beam (a laser spot) may be fuzzy or a dim light circle (halo) may be generated around the laser spot. As a result, light may be projected to tracks other than the track from which information is reproduced, so that cross talk and jitter increases, which causes deterioration of accuracy in reproducing data. In the present invention, the liquid crystal element 7 described above is used for correcting such wave aberration.

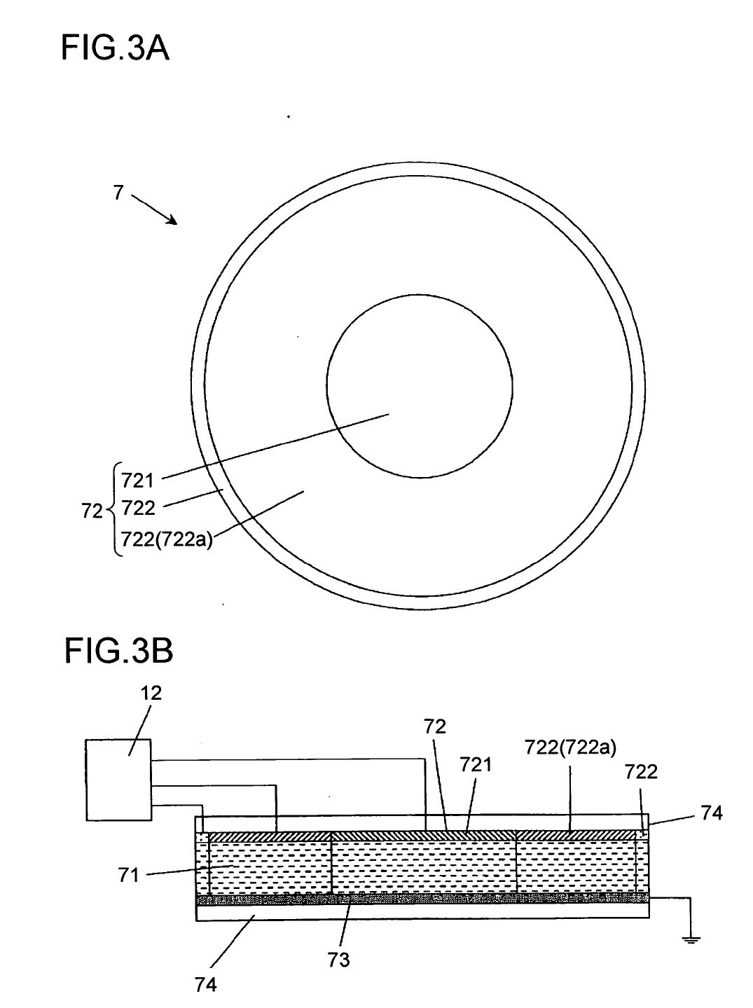

FIG. 3A is a plan view of the liquid crystal element that is used in the optical disc apparatus of the present invention, and FIG. 3B is a cross sectional view of the liquid crystal element shown in FIG. 3A. The liquid crystal element 7 shown in FIGS. 3A and 3B includes a liquid crystal layer 71 that has refractive index changing in accordance with applied voltage, transparent electrodes 72 and 73 sandwiching the liquid crystal layer 71, and glass substrates 74 sandwiching them. As the transparent electrodes 72 and 73, a transparent conductive film such as an ITO (Indium Tin Oxide) film or the like is used widely though it is not a limitation.

As shown in FIG. 3A, one of the transparent electrodes 72 of the liquid crystal element 7 includes a disk like transparent electrode 721 that is disposed in the middle and two circular transparent electrodes 722 surrounding the disk like transparent electrode 721. The disk like transparent electrode 721 and the circular transparent electrodes 722 are formed independently of each other. In other words, the transparent electrodes 721 and 722 can be supplied with different voltages, respectively, via the liquid crystal driver 12. The liquid crystal driver 12 can be a circuit that can apply appropriate voltages to the disk like transparent electrode 721 and/or the circular transparent electrodes 722 though it is not a limitation.

Although the transparent electrodes are arranged with spaces between them in this embodiment, the present invention should not be limited to this structure. It is possible to dispose insulator portions between the transparent electrodes. In addition, the other transparent electrode 73 is a single disk like transparent electrode that is connected to the ground, though it is not a limitation.

Although the liquid crystal element 7 has two circular transparent electrodes 722 as one embodiment, the present invention should not be limited to this structure. The liquid crystal element 7 may have more circular transparent electrodes. In this case too, neighboring transparent electrodes should be arranged separately.

When an individual voltage is applied to each of the disk like transparent electrode 721 and/or the circular transparent electrodes 722, partially different electric fields are formed on the liquid crystal layer 71 so that the refractive index of the liquid crystal layer 71 is changed partially as an influence of the electric fields. The laser beam that passed through the portion having the changed refractive index has a phase shifted from that of the other laser beam that passed through the other part. This shift of phase is determined by the voltage (potential difference) that is applied to the liquid crystal layer 71.

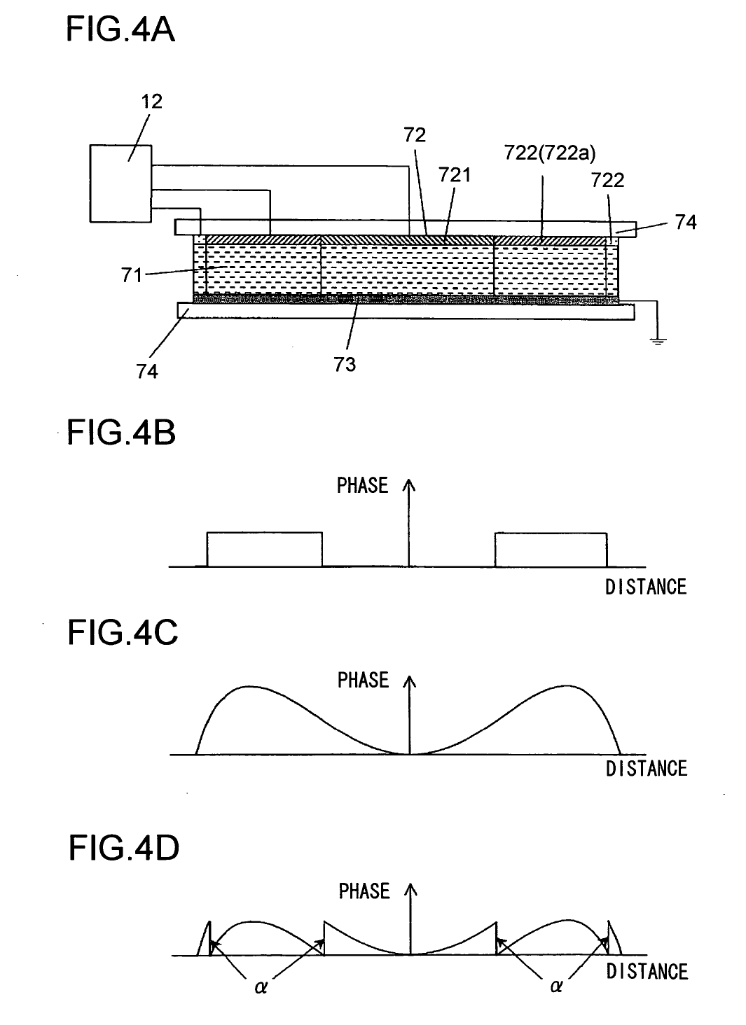

Next, a method for correcting aberration of the laser beam by using the liquid crystal element 7 shown in FIGS. 3A and 3B will be described. FIG. 4A is a cross sectional view of the liquid crystal element, FIG. 4B shows a correction pattern of a phase when voltages are applied to the transparent electrodes of the liquid crystal element, FIG. 4C shows wave aberration before correction generated on a recording layer of a DVD medium when the DVD medium is read, and FIG. 4D shows wave aberration when a laser beam is condensed on the recording layer of the DVD medium after being corrected by the liquid crystal element. In FIGS. 4B, 4C and 4D, the horizontal axis represents a radius, and the vertical axis represents a phase (wavelength). The wave aberration, the correction pattern and the wave aberration after the correction shown in each of FIGS. 4B, 4C and 4D are schematic values, and actual values generated when a DVD medium is read may be different from those.

As to the liquid crystal element 7 shown in FIG. 4A, a voltage is applied to an inner transparent electrode 722a out of the two circular transparent electrodes 722. When the voltage is applied to the inner transparent electrode 722a, an electric field is generated between the transparent electrode 722a and the transparent electrode 73, so that the refractive index of the liquid crystal layer 71 in this part is changed. If the laser beam having no aberration passes through the liquid crystal element 7 in the above mentioned state, the laser beam having the correction pattern (phase difference) as shown in FIG. 4B goes out from the liquid crystal element 7.

When the optical disc apparatus A of the present invention is used for projecting the laser beam to a DVD medium, wave aberration as shown in FIG. 4C is generated in the case where aberration is not corrected, because the objective lens 9 supports a BD medium. The voltage is applied to the transparent electrode 722a of the liquid crystal element 7, and the correction as shown in FIG. 4B is performed in advance on the laser beam that passes through the liquid crystal element 7. As a result, the laser beam that is condensed on the recording layer generates wave aberration having a pattern as shown in FIG. 4D. In other words, the wave aberration pattern shown in FIG. 4D is obtained by subtracting the correction pattern shown in FIG. 4B from the wave aberration shown in FIG. 4C.

In this way, since the wave aberration is corrected so that the phase shift is within a constant range, the spot diameter of the laser spot condensed on the recording layer when a DVD medium is read can be decreased so that generation of the halo can be suppressed.

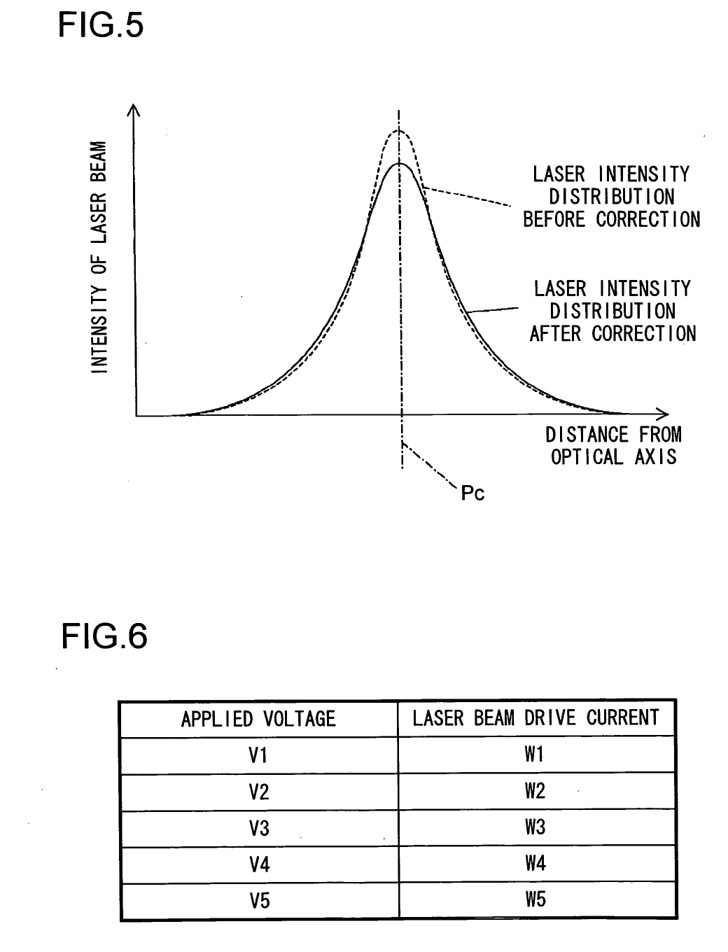

FIG. 5 is a schematic diagram to show an intensity distribution of the laser beam. In the intensity distribution shown in FIG. 5, the vertical axis indicates intensity of the laser beam, and the horizontal axis indicates a distance from the optical axis Pc of the laser beam. In addition, a broken line indicates an intensity distribution of the laser beam that is condensed on the recording layer without the correction of aberration (the intensity distribution of the laser beam shown in FIG. 4C), and a solid line indicates an intensity distribution of the laser beam on the recording layer after its aberration is corrected by the liquid crystal element 7 (the intensity distribution of the laser beam shown in FIG. 4D). As shown in FIG. 5, the intensity distribution of the laser beam has high intensity in the vicinity of the optical axis, and the intensity drops largely as being away from the optical axis.

The laser beam in the vicinity of the optical axis is an effective laser beam that contributes to reproduction, which is projected to the recording layer of the optical disc Ds. As shown in FIG. 5, intensity of the effective light in the vicinity of the optical axis of the laser beam after its aberration is corrected is lower than intensity of the effective light of the laser beam without the correction of aberration. This is because that when the laser beam is corrected by the liquid crystal element 7, aberration component that cannot be corrected is eliminated as unavailable light having high order aberration. In other words, the part formed in parallel with the vertical axis of the wave aberration pattern after the correction shown in FIG. 4D (the part shown by a in FIG. 4D) is eliminated as the high order aberration.

Therefore, in the optical disc apparatus A, correction of increasing the output power of the laser beam emitted from the blue color laser beam source 1 or the red color laser beam source 2 is performed so as to compensate a decrease of intensity of the laser beam of the effective light in the case where aberration of the laser beam is corrected by the liquid crystal element 7.

Hereinafter, a correction control of the wave aberration when the optical disc apparatus A of the present invention reads a DVD medium will be described. The control portion 15 checks if the optical disc apparatus A is loaded with a DVD medium and controls the laser driver 13 to supply current so that the red color laser beam source 2 emits the red color laser. In this case, the current to be supplied from the laser driver 13 to the red color laser beam source 2 is a drive current having an initial value that is preset in the memory 14.

In addition, since wave aberration is generated on the recording layer of a DVD medium when the DVD medium is read, the control portion 15 issues an instruction to the liquid crystal driver 12, and the liquid crystal driver 12 applies a liquid crystal drive voltage supporting a DVD medium to the circular transparent electrode 722a. In this case, the voltage to be applied by the liquid crystal driver 12 has a set value that is determined for each medium in advance. The set value is stored in the memory 14, and the control portion 15 looks up this set value for issuing the instruction to the liquid crystal driver 12.

The memory 14 stores a correction table of the drive current for the red color laser beam source 2 with a parameter that is a correction value for the liquid crystal element 7 (an applied voltage to the transparent electrode 722a). FIG. 6 shows one embodiment of the correction table. A first correction table T1 shown in FIG. 6 indicates drive current for the red color laser beam source 2 with a parameter that is the correction value for the liquid crystal element 7.

The control portion 15 looks up the first correction table T1 stored in the memory 14 and issues an instruction to the laser driver 13 to correct the drive current based on the correction value of the liquid crystal element 7. The laser driver 13 that is instructed to perform the correction supplies the corrected drive current to the red color laser beam source 2.

For example, if a value of the voltage that is applied to the circular transparent electrode 722a by the liquid crystal driver 12 is V3, the control portion 15 looks up the first correction table T1 stored in the memory 14 and obtains a value W3 of current to be supplied to the red color laser beam source 2 corresponding to the voltage value V3. After that, the control portion 15 issues an instruction to the laser driver 13 to make current to be supplied to the red color laser beam source 2 be the value W3. The laser driver 13 that received the instruction corrects the current to be supplied to the red color laser beam source 2 to be W3.

After that, every time when the voltage applied to the circular transparent electrode 722a by the liquid crystal driver 12 changes due to a certain factor, the control portion 15 looks up the first correction table T1 stored in the memory 14 and determines a correction value of the current to be supplied to the red color laser beam source 2 corresponding to the applied voltage. Then, the control portion 15 issues an instruction to the laser driver 13 to correct the drive current. The laser driver 13 that is instructed to perform the correction supplied the corrected drive current to the red color laser beam source 2.

Although in this embodiment the first correction table T1 includes values of the applied voltage and values of the drive current that are associated with each other, the present invention should not be limited to this structure. For example, it is possible to structure so that a value of drive power has a constant range with respect to the applied voltage. It is possible to adopt the correction table widely, which can be used for the correction so that the laser beam having intensity that is necessary for reading information can be emitted from the red color laser beam source 2.

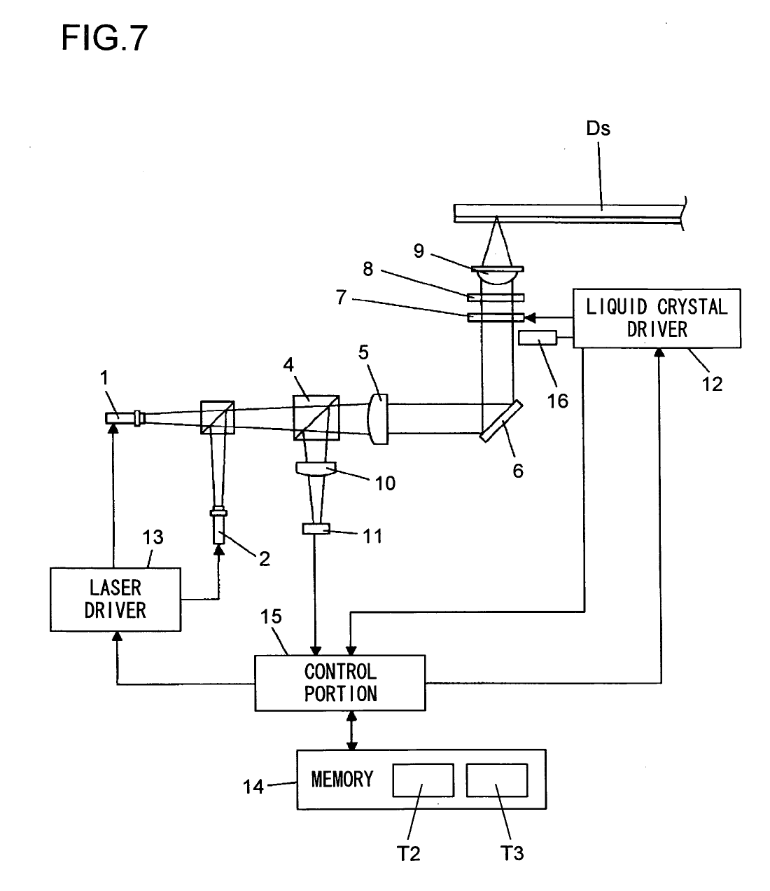

FIG. 7 shows a schematic arrangement of the optical disc apparatus according to another embodiment of the present invention. An optical disc apparatus A2 shown in FIG. 7 is equipped with a temperature sensing portion 16 for sensing temperature of the liquid crystal element 7 (or the atmosphere of the liquid crystal element 7) in the vicinity of the liquid crystal element 7. The memory 14 stores a second correction table T2 and a third correction table T3 of the liquid crystal element 7. Other parts have the same structures as those of the optical disc apparatus A shown in FIG. 1, and the substantially same parts are denoted by the same reference numerals.

As shown in FIG. 7, the liquid crystal temperature sensing portion 16 is disposed to contact with the liquid crystal element 7 or disposed in a non-contact manner in the vicinity of the liquid crystal element 7 for sensing temperature of the liquid crystal element 7. As the liquid crystal temperature sensing portion 16, a thermistor, a thermocouple, a radiation thermometer, or the like can be used for example.

The liquid crystal temperature sensing portion 16 is connected to the control portion 15, and temperature of the liquid crystal element 7 (or temperature in the vicinity of the liquid crystal element 7) sensed by the liquid crystal temperature sensing portion 16 is sent to the control portion 15. When temperature of the liquid crystal element 7 rises, the refractive index thereof is changed. When the refractive index is changed, the aberration may not be corrected. In this case, a part of the laser beam condensed on the recording layer that is eliminated as unavailable light may be decreased. Since the output power of the red color laser beam source 2 is corrected to compensate the eliminated part as the unavailable light, intensity of the effective light may increase when the eliminated unavailable light is decreased. In this case, excessive intensity of the laser beam exceeding an allowable range that can be projected to the recording layer of the optical disc Ds may be condensed. If the excessive intensity of the laser beam exceeding an allowable range is projected to the recording layer, the recording layer of the optical disc can be damaged resulting in deletion of recorded information.

Therefore, the memory 14 stores the second correction table T2 of current to be supplied to the red color laser beam source with a parameter that is the liquid crystal temperature for each correction value of the liquid crystal element 7. The control portion 15 looks up the second correction table T2 and determines a correction value of the current to be supplied to the red color laser beam source 2 based on the temperature sensed by the liquid crystal temperature sensing portion 16. The control portion 15 issues an instruction to the laser driver 13 to supply the corrected current to the red color laser beam source 2. The laser driver 13 that received the instruction supplies the corrected current to the red color laser beam source 2. Thus, intensity of the effective light of the laser beam to be projected to the recording layer is maintained at a constant level so that damage to the recording layer can be reduced.

In this state, however, the refractive index of the liquid crystal element 7 is changed, so there is the case where wave aberration of the laser beam on the recording layer cannot be corrected sufficiently. Therefore, the control portion 15 should correct the voltage applied to the circular transparent electrode 722a of the liquid crystal element 7 based on the temperature of the liquid crystal element 7. The third correction table T3 stored in the memory 14 includes correction values of the liquid crystal element 7 (voltages to be applied to the circular transparent electrode 722a) with a parameter that is the temperature of the liquid crystal element 7. The control portion 15 looks up this third correction table T3 so as to control the correction value of the liquid crystal element 7.

The control portion 15 looks up the third correction table T3 stored in the memory 14 and determines a correction value of the liquid crystal element 7 corresponding to the temperature of the liquid crystal element 7 sensed by the liquid crystal temperature sensing portion 16. Then, the control portion 15 issues an instruction to the liquid crystal driver 12 to apply the corrected voltage to the circular transparent electrode 722a. In this case, the control portion 15 looks up the second correction table T2 based on the correction value of the liquid crystal element 7 and the temperature of the liquid crystal element 7 so as to determine a correction value of current to be supplied to the red color laser beam source 2. Then, the control portion 15 issues an instruction to the laser driver 13 to correct the drive voltage. The laser driver 13 that received the instruction supplies the corrected drive voltage to the red color laser beam source 2.

In this way, the control portion 15 controls the liquid crystal driver 12 and the laser driver 13, i.e., the liquid crystal element 7 and the red color laser beam source 2, so that wave aberration of the laser beam that is projected to the recording layer of the optical disc Ds is corrected. Since the spot diameter of the laser beam that is condensed on the recording layer is reduced and intensity of the laser beam can be controlled within an allowable range to the recording layer constantly, erasure of information due to damage to the recording layer of the optical disc Ds can be avoided. In addition, since an appropriate laser spot is formed on the recording layer, a good accuracy in reproduction can be maintained.

In the embodiment described above, the device is provided with the second correction table T2 of the output power of the red color laser beam source 2 (drive voltage of the red color laser beam source) with a parameter that is temperature of the liquid crystal element 7 for each correction value of the liquid crystal element 7 (an applied voltage to the circular transparent electrode 722a) and the third correction table T3 of the correction value of the liquid crystal element 7 with a parameter that is temperature of the liquid crystal element 7. However, the present invention should not be limited to this structure. It is possible to provide an output power table of the red color laser beam source 2 with parameters that are the correction value of the liquid crystal element 7 and temperature of the liquid crystal element 7 and to determine an output power of the laser beam source based on the correction value and the temperature of the liquid crystal element.

Furthermore, in each embodiment described above, aberration and intensity of the laser beam are corrected when a DVD medium is read by the optical system equipped with the objective lens that supports reading of a BD medium. However, the present invention should not be limited to that case, but it can be used in the case where a CD medium is read and in the case where a BD medium having a two-layered or multilayered recording layer is read. In addition, the present invention can be used in the case where information is recorded on a writable medium without being limited to the reading case. In addition, although the embodiment described above uses the single red color laser beam source as the laser beam source for emitting the red color laser beam supporting a DVD medium and the infrared laser beam supporting a CD medium, it is possible to provide two laser beam sources for emitting the infrared laser and the red color laser.

Further in the embodiment described above, the transparent electrodes 72 of the liquid crystal element 7 includes the disk like transparent electrode 721 disposed at the middle and two circular transparent electrodes 722 disposed around the disk like transparent electrode 721 in a concentric manner. However, the present invention should not be limited to this structure. It is possible to arrange more transparent electrodes to which voltages are applied separately, so that accuracy in correcting wave aberration can be enhanced. In this case, the correction table can be prepared for each pattern of applying the voltage with parameters that are temperature of the liquid crystal element and output power of the laser beam. In addition, the shape and the arrangement of the electrodes are not limited to the concentric disk like and/or circular shape.

The present invention can be applied to an optical disc apparatus using an optical disc such as a BD, a DVD, a CD or the like as a recording medium.

What is claimed is:

1. An optical disc apparatus comprising:
a plurality of laser beam source for emitting laser beams having different wavelengths;
an objective lens for condensing a laser beam emitted from one of the plurality of laser beam source on a recording surface of one of optical discs including a CD, a DVD and a BD;
a liquid crystal element for permitting the laser beam to pass through and for correcting aberration of the laser beam;
a liquid crystal driver for applying a drive voltage to the liquid crystal element;
a laser driver for supplying current for driving the laser beam source;
a storage portion for storing various types of information; and
a control portion for controlling the liquid crystal driver, the laser driver, and the storage portion, wherein
the storage portion stores a correction table of the current to be supplied to the laser beam source with a parameter of the voltage to be applied to the liquid crystal element, and
the control portion looks up the correction table when the laser beam is projected to the optical disc, and the control portion determines a correction value of the current for driving the laser beam source in accordance with the voltage to be applied to the liquid crystal element.

2. The optical disc apparatus according to claim 1, wherein
the optical disc apparatus includes a liquid crystal temperature sensing portion for sensing temperature of the liquid crystal element,
the correction table includes temperature of the liquid crystal element as the parameter, and
the control portion determines the correction value of the current for driving the laser beam source in accordance with the voltage to be applied to the liquid crystal element and the temperature of the liquid crystal element sensed by the liquid crystal temperature sensing portion.

3. The optical disc apparatus according to claim 1, wherein
the liquid crystal element is provided with a disk like transparent electrode disposed on a liquid crystal layer and a plurality of circular transparent electrodes arranged in a concentric manner around the disk like transparent electrode with being insulated from each other, and
the liquid crystal driver applies the voltage to each of the plurality of transparent electrodes independently.

4. The optical disc apparatus according to claim 2, wherein
the liquid crystal element is provided with a disk like transparent electrode disposed on a liquid crystal layer and a plurality of circular transparent electrodes arranged in a concentric manner around the disk like transparent electrode with being insulated from each other, and
the liquid crystal driver applies the voltage to each of the plurality of transparent electrodes independently.

5. The optical disc apparatus according to claim 1, wherein the optical disc apparatus is for reading only.

6. The optical disc apparatus according to claim 2, wherein the optical disc apparatus is for reading only.

7. The optical disc apparatus according to claim 3, wherein the optical disc apparatus is for reading only.

8. An optical disc apparatus for reproducing information by projecting a laser beam on a recording surface of an optical disc and detecting a reflection light of the laser beam, the optical disc apparatus comprising:
a blue color laser beam source for emitting a first laser beam of a blue color;
a red color laser beam source for emitting a second laser beam of a red color or infrared;
an objective lens for condensing the first or the second laser beam on a recording surface of one of optical discs including a CD, a DVD and a BD;
a liquid crystal element having a liquid crystal layer, a disk like transparent electrode disposed on the liquid crystal layer and a plurality of circular transparent electrodes surrounding the disk like transparent electrode in a concentric manner with being separated from each other for changing a refractive index of the liquid crystal layer by applying voltages to the plurality of transparent electrodes so that aberration of the laser beam passing through the liquid crystal layer is corrected;
a liquid crystal temperature sensing portion for sensing temperature of the liquid crystal element;
a liquid crystal driver for applying voltages to the plurality of transparent electrodes independently;
a laser driver for supplying current for driving one of the blue color laser beam source and the red color laser beam source in accordance with a type of the optical disc to which the laser beam is projected;
a memory for storing various types of information; and
a control portion for controlling the liquid crystal temperature sensing portion, the liquid crystal driver, the laser driver, and the memory, wherein
the memory stores a correction table of the current for driving to be supplied to the blue color laser beam source or the red color laser beam source with parameters that are the temperature of the liquid crystal element and the voltages to be applied to the plurality of transparent electrodes, and
the control portion looks up the correction table when the laser beam is projected to the optical disc, and the control portion determines a correction value of the current for driving the blue color laser beam source or the red color laser beam source in accordance with the voltages to be applied to the plurality of transparent electrodes and the temperature of the liquid crystal element sensed by the liquid crystal temperature sensing portion.
